(19) United States
(12) Patent Application Publication
(10) Pub. No.: US 2026/0217751 A1
(43) Pub. Date: Jul. 30, 2026

(54) SELECTIVE CARBON MONOXIDE UPTAKE BY POROUS MATERIALS WITH METAL CARBANIONS

(71) Applicant: THE REGENTS OF THE UNIVERSITY OF CALIFORNIA, Oakland, CA (US)

(72) Inventors: Jeffrey R. Long, Lafayette, CA (US); Jesse L. Peltier, Berkeley, CA (US); Kurtis M. Carsch, Berkeley, CA (US); Jonas Boergel, Berkeley, CA (US)

(73) Assignee: THE REGENTS OF THE UNIVERSITY OF CALIFORNIA, Oakland, CA (US)

(21) Appl. No.: 19/453,514

(22) Filed: Jan. 20, 2026

Related U.S. Application Data
(63) Continuation of application No. PCT/US2024/039863, filed on Jul. 26, 2024.
(60) Provisional application No. 63/516,154, filed on Jul. 28, 2023.

(51) Int. Cl. C07F 15/06; B01D 53/04; B01J 20/22

(52) U.S. Cl. CPC C07F 15/06; B01D 53/04; B01J 20/226; B01D 2256/10; B01D 2256/16; B01D 2256/245; B01D 2257/502

(57) ABSTRACT

Metal organic framework compositions and methods for CO gas separations from mixed gas sources are provided. A modified CO-selective metal-organic framework M-R-MFU-4l, where M is a divalent metal and R is a carbon substituent is particularly effective for CO separations. The material remains intact upon exposure to CO and retains high capacities over extended cycling. One framework, Co_{3.8}Zn_{1.2}Me_{3.8}Cl_{0.2}(btdd)₃, CoMe-MFU-4/, leverages pseudo-open metal sites for a highly effective separation process. Because of the spin transition mechanism and the reorganization induced by a strong field ligand, the framework selectively coordinates multiple CO to each Co single site at 25 degrees Celsius. The sluggish desorption of CO in contrast to other potential components in a gaseous stream which desorb rapidly, such as N₂, H₂, CH₄, ethylene, facilitates the isolation of high purity CO via a kinetic separation.

### CROSS-REFERENCE TO RELATED APPLICATIONS

This application claims priority to, and is a 35 U.S.C. § 111(a) continuation of, PCT international application number PCT/US2024/039863 filed on Jul. 26, 2024, incorporated herein by reference in its entirety, which claims priority to, and the benefit of, U.S. provisional patent application Ser. No. 63/516,154 filed on Jul. 28, 2023, incorporated herein by reference in its entirety. Priority is claimed to each of the foregoing applications.

The above-referenced PCT international application was published as PCT International Publication No. WO 2025/029669 A1 on Feb. 6, 2025, which publication is incorporated herein by reference in its entirety.

### STATEMENT REGARDING FEDERALLY SPONSORED RESEARCH OR DEVELOPMENT

This invention was made with Government support under Grant No. DE-SC0019992 awarded by the United States Department of Energy. The Government has certain rights in the invention.

### NOTICE OF MATERIAL SUBJECT TO COPYRIGHT PROTECTION

A portion of the material in this patent document may be subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

The technology of this disclosure pertains generally to methods and compositions for gas separations and capture and more particularly to a CO-selective metal-organic framework family with formula of M-R-MFU-4/, where M is a divalent metal and R is a carbon substituent. Optimized performance is shown for CoMe-MFU-4/ (Co_{3.8}Zn_{1.2}Me_{3.8}Cl_{0.2}(btdd)₃), which utilizes pseudo-open metal sites for a highly effective separation process.

### 2. Background Discussion

Carbon monoxide gas has been recognized as both a valuable industrial feedstock and as an undesirable pollutant. High purity carbon monoxide (CO, >99 mol %) is a valuable feedstock chemical used in a range of applications (e.g., Fischer Tropsch, Koch reaction, phosgene synthesis, and food packaging). Substantial amounts of CO are produced through petroleum, fossil fuel combustion, and steel manufacturing; however, the CO produced in these processes is present in a complex mixture of gases, often contaminated with H₂, N₂, and CH₄.

Conventional processes for the purification of CO require the use of thermal distillations systems that rely on energy intensive cryogenic liquefaction that are costly to create and operate. The similar boiling point and other physical properties between N₂ and CO further complicates the ability to obtain high purity CO negatively. Overall, the energetically inefficient nature of CO purification leads to a significant portion of potential feedstocks being used only for their caloric value.

The development of an adsorbent-based approach to capture and purify CO under milder conditions affords promise in alleviating the energy and capital expenditures. The realization of milder separation conditions for CO will open the availability of new feedstocks to obtain high purity CO, minimize CO₂ emissions from CO combustion, and improve upon existing industrial separations. However, suitable adsorbent materials for the energy-efficient and selective purification of CO from multicomponent mixtures remain inadequate due to a lack of frameworks capable of strong, selective, and reversible CO capture. The selective coordination of multiple gases to a single site would afford a potent strategy for enhancing capacity and purity values beyond benchmark sorbents. However, suitable adsorbent materials for the energy-efficient and selective purification of CO from multicomponent mixtures remain inadequate due to a lack of frameworks capable of strong, selective, and reversible CO capture.

Accordingly, there is a need for new CO separation materials that are efficient, effective separators of multiple gas type sources, inexpensive to manufacture, easy to use, do not require significant cryogenic temperatures, and provide substantial capital and energy savings over current processes.

### BRIEF SUMMARY

Metal organic framework compositions and methods for CO gas separations from multiple component mixture (e.g., N₂, H₂, CH₄, ethylene) effluent gas sources are provided. The family of metal-organic frameworks for CO separations has the general formula M-R-MFU-4/, where M is a divalent metal and R is a carbon substituent. Particularly preferred metals are selected from the group of Mn, Fe and Co and the preferred R substituents are selected from the group of alkanes, alkenes, and alkynes or from the group of vinyl, aryl, and alkynyl substituents.

The technology centers on the transformation of metal-organic frameworks of the type Zn₅Cl₄(btdd)₃ (MFU-4/), which consists of pentanuclear metal cluster nodes and bistriazolate ligands (H₂btdd=bis(1H-1,2,3-triazolo[4,5-b],[4′,5′-i])dibenzo[1,4]dioxin) featuring cubic pores. The nodes feature a central zinc ion in an octahedral geometry and four metal centers on the periphery of each cluster with a terminal chloride ligand bound. The peripheral zinc ions can be fully exchanged for Co^{II} to access Co₄ZnCl₄(btdd)₃ (CoCl-MFU-4/), and the terminally bound chloride can be replaced by strong field alkyl ligands as illustrated in FIG. 1.

One preferred newly modified CO-selective metal organic framework, Co_{3.8}Zn_{1.2}Me_{3.8}Cl_{0.2}(btdd)₃, CoMe-MFU-4/, which leverages the concept of pseudo-open metal sites for highly effective separation processes. Because of the spin transition mechanism and the reorganization induced by a strong field ligand, the framework selectively coordinates multiple CO to each Co single site at 25 degrees Celsius. This feature enables the realization of a material that overcomes existing limitations and achieves CO capacity and purity values beyond benchmark sorbents. The material remains intact upon exposure to CO and retains high capacities over extended cycling.

Mechanistic and kinetic insights are obtained through detailed characterization. Notably, the sluggish desorption of CO in contrast to other potential components in a source mixture (e.g., N₂, H₂, CH₄, ethylene), which desorb rapidly, facilitates the isolation of high purity CO via a kinetic separation.

The selective capture and recovery of CO from multicomponent mixtures presents many different possible applications that rely on high purity CO (CO>99 mol %). Industrial separations exploit vapor pressure differences between CO and other potential components in a mixture (e.g., N₂, H₂, CH₄ and ethylene) via energy intensive cryogenic distillation. The realization of milder separation conditions for CO will open new feedstocks to obtain high purity CO, minimize CO₂ emissions from CO combustion, and improve upon existing industrial separations.

The frameworks provide methods for gas separations that can be adapted to various multi component gas sources through the selection of framework metals and substituents. For example, one simple method for CO gas separations comprises, (a) providing a bed of metal organic frameworks of formula M-R-MFU-4/, where M is a divalent metal and R is a carbon substituent; (b) exposing the bed of metal organic frameworks to a flow of gases to be separated; and (c) releasing adsorbed gases from the metal organic frameworks after a period of time.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE DRAWINGS

The technology described herein will be more fully understood by reference to the following drawings which are for illustrative purposes only:

FIG. 1 is a schematic illustration of the metal organic framework with cubic pores for Co₄Zn(Me)₄(btdd)₃ using single-crystal x-ray diffraction data (left) and the expanded view of the truncated structure of a cluster node of the framework showing the nature of the methyl coordination (right) according to one embodiment of the technology.

FIG. 2 is a schematic illustration of the local structure for the high-spin tetrahedral Co^{II} sites and the synthetic protocol that yields Co—Me sites in the material shown in FIG. 1.

FIG. 3 is a schematic illustration of the local coordination environment of the Co^{II}—Me sites in CoMe-MFU-4/ and the observed selective multi-gas sorption for CO that transpires at the Co sites.

FIG. 4 is a plot of single component isotherms for the CoMe-MFU-4/ framework. Nitrogen surface area adsorption data (filled circles) and nitrogen desorption data (open circles) measured at 77 K for CoCl-MFU-4/ and CoMe-MFU-4/ with the corresponding surface area tabulated in the table inset. The CoMe-MFU-4/ material remains intact after salt metathesis with CoCl-MFU-4/.

FIG. 5 is a plot of single component isotherms (adsorption data, filled circles and desorption data open circles) for CoMe-MFU-4/ and CoCl-MFU4/ at 298 K that demonstrates the effect of changing the chloride to methyl and demonstrates that CoMe-MFU-4/ features steep uptake for CO at low pressures in contrast to ethylene, ethane, methane, dinitrogen, and dihydrogen.

FIG. 6 is a plot of electron paramagnetic resonance spectroscopy measurements collected at X Band at 10 K with 5 G modulation for CoMe-MFU-4/ undosed material (top), and in-situ CO-dosed material (bottom).

FIG. 7 is a plot of magnetic susceptibility measurements at field strengths between 1000 Oe and 10,000 Oe for CoMe-MFU-4/ showing high-spin Co^{II} consistent with an S= 3/2 species.

FIG. 8 is a plot of magnetic susceptibility measurements at field strengths between 1000 Oe and 10,000 Oe for CO dosed CoMe-MFU-4/ showing low-spin Co^{II} consistent with an S=½ species.

FIG. 9 is a plot of powder patterns for CO-dosed CoMe-MFU-4/ collected between 80 K and 298 K at various pressures of CO. The inset shows a portion of the patterns stacked in the y-axis direction based on the experimental conditions at which the data were collected, which is indicated to the right of the plot. As the pressure of CO increases, a unit cell contraction transpires indicative of a transition from high-spin to low-spin.

FIG. 10 is a plot of DRIFTS spectra that was obtained after dosing CoMe-MFU-4/ with varying pressures of CO from 0.292 mbar to 1 bar at 300 K. The formation of a Co-acyl species in the material from CO migratory insertion is demonstrated by the resonance positioned at ~1675 cm⁻¹ showing the mechanism of adsorption between CoMe-MFU-4/ and CO using variable-temperature in-situ DRIFTS.

FIG. 11 is a plot of DRIFTS measurements of CoMe-MFU-4/ with in-situ CO dosing at 1 bar starting at 100 K and then warmed up to 300 K which shows the barrier to acyl formation by the onset of the peak at peak at ~1675 cm⁻¹.

FIG. 12 is a schematic representation of other congeners of MₓZn₅₋ₓ(R)₄(btdd)₃ and their potential binding of CO. Some examples for M and R are given, which generally denotes divalent transition metals, and alkyl, aryl, vinyl, or acetylide type substituents, respectively.

### DETAILED DESCRIPTION

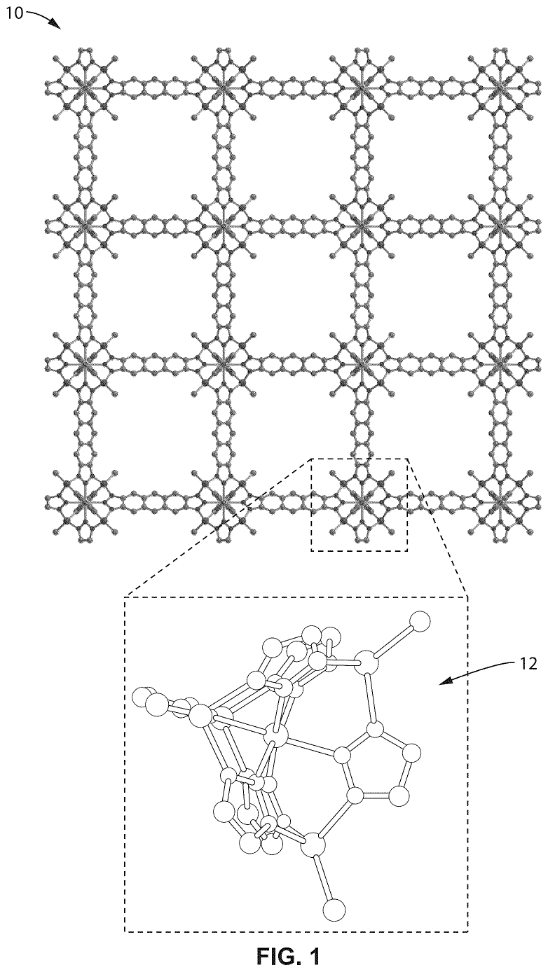

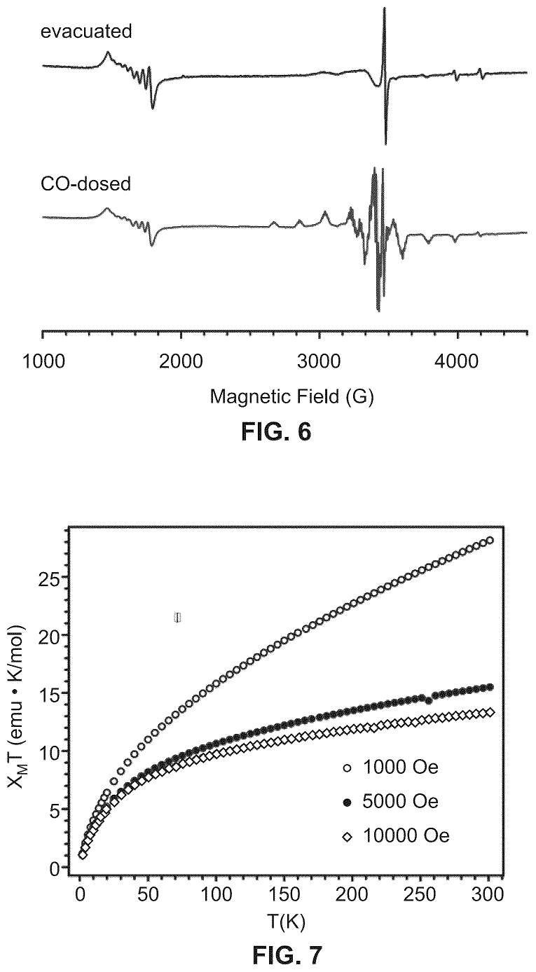

Referring more specifically to the drawings, for illustrative purposes, compositions, materials and methods for the capture and recovery of high-purity CO from composite gas streams are generally shown. Several embodiments of the technology are described generally in FIG. 1 to FIG. 12 to illustrate the characteristics and functionality of the family of metal-organic frameworks and methods. It will be appreciated that the methods may vary as to the specific steps and sequence and the systems and apparatus may vary as to structural details without departing from the basic concepts as disclosed herein. The method steps are merely exemplary of the order that these steps may occur. The steps may occur in any order that is desired, such that it still performs the goals of the claimed technology.

A family of CO-selective metal-organic framework compositions of organic framework M-R-MFU-4/, where M is a divalent metal and R is a carbon substituent, and methods of use are provided. The CO adsorption properties of Cu^{I}-MFU-4/ using gas adsorption, spectroscopic, and breakthrough analyses are demonstrated.

Turning now to FIG. 1, a schematic illustration of a metal organic framework 10 with cubic pores for Co₄Zn(Me)₄(btdd)₃ using single-crystal x-ray diffraction data is shown along with an expanded view of the truncated structure of a cluster node 12 of the framework showing the nature of the methyl coordination shown in the inset.

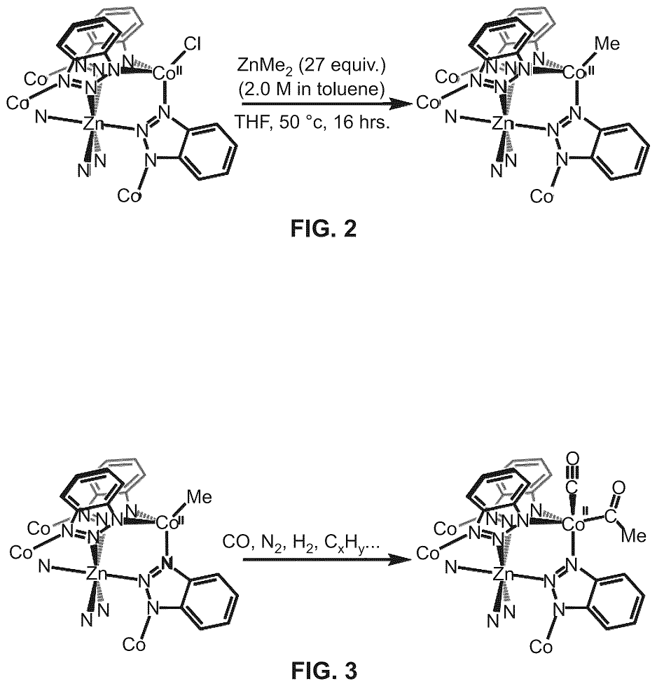

The local structure for the high-spin tetrahedral Co^{II} sites and the synthetic protocol that yields Co—Me sites in the material shown in FIG. 1 is shown schematically in FIG. 2. The local coordination environment of the Co^{II}—Me sites in CoMe-MFU-4/ and the observed selective multi-gas sorption for CO that transpires at the Co sites is shown schematically in FIG. 3.

The family of frameworks 10 is generally centered on the transformation of metal-organic frameworks of the type Zn₅Cl₄(btdd)₃ (MFU-4/), which consists of pentanuclear metal cluster nodes and bistriazolate ligands (H₂btdd=bis(1H-1,2,3-triazolo[4,5-b], [4′,5′-i])dibenzo[1,4]dioxin) featuring cubic pores. The nodes feature a central zinc ion in an octahedral geometry and four metal centers on the periphery of each cluster with a terminal chloride ligand bound. The peripheral zinc ions can be fully exchanged for Co^{II} to access Co₄ZnCl₄(btdd)₃ (CoCl-MFU-4/), and the terminally bound chloride can be replaced by strong field alkyl ligands as shown in FIG. 1.

The framework 10 materials are expected to show the best performance in a breakthrough setup. Multicomponent mixtures of CO, hydrocarbons, H₂, and N₂ will be flown over the system with a certain pressure and temperature depending on the setup. After selective CO capture, pure CO can be retained and can then be liberated by the flow of inert gas, vacuum swing, or temperature swing processes. The pure carbon monoxide may then be collected selectively at the outlet after the separation process. Possibly, by-products from methyl decomposition, or minimal amounts of impurities such as hydrocarbons, H₂ and N₂ can be collected at the outlets as well.

The exchange of peripheral zinc ions for Co^{II} to access Co₄ZnCl₄(btdd)₃ (CoCl-MFU-4/), and the terminally bound chloride that can be replaced by strong field alkyl ligands to produce the framework is shown in FIG. 1. Under an inert atmosphere, dimethylzinc (27 equiv.) in toluene (2.0 M) was added to a suspension of CoCl-MFU-4/ (1.0 equiv.) in tetrahydrofuran (4 mL). The mixture was agitated and allowed to stand at 50° C. for 16 hours. Afterward, the solution was cooled down to room temperature, and the supernatant was subsequently decanted and replaced with a fresh equimolar solution of dimethylzinc (27 equiv.) in tetrahydrofuran. The mixture was allowed to stand for an additional 16 hours at 50° C. and the process was repeated one more time for three total iterations.

Subsequently, the supernatant was decanted, and the solids were soaked twice in tetrahydrofuran (5 mL) at 50° C. for a minimum of 4 hours each and soaked four times in diethyl ether (5 mL) at 25° C. for a minimum of 4 hours each iteration. Then, the solids were evacuated under dynamic vacuum at 50° C. (0.1° C./min ramp rate) for a minimum of 48 hours to afford the activated framework, CoMe-MFU-4/. The CoMe-MFU-4/ material was characterized by a variety of techniques including single crystal X-ray diffraction, powder X-ray diffraction, isothermal adsorption measurements, electron paramagnetic resonance spectroscopy, infrared spectroscopy, and magnetic susceptibility measurements.

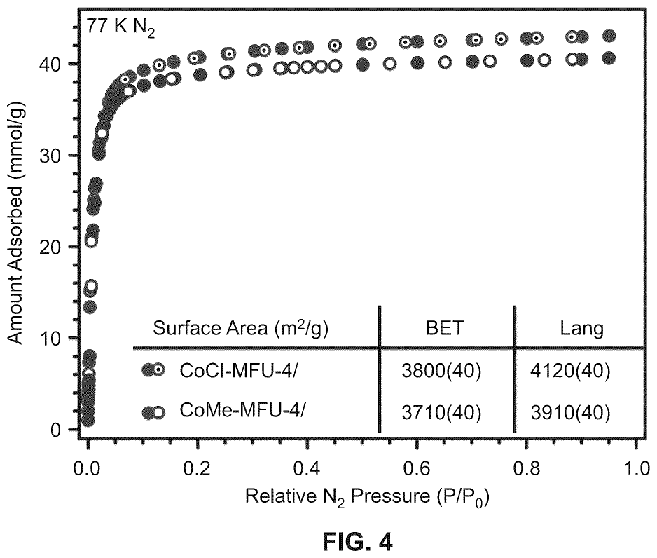

As expected, exchanging chlorides for the bulkier methyl groups causes a mild decrease in the surface area of the material. By comparison with surface area measurements for CoCl-MFU-4/ with N₂ at 77 K, the post-synthetic methyl exchange yields CoMe-MFU-4/ that remains intact and leads to only a small decrease in the surface area (see FIG. 4). This framework features high-spin tetrahedral Co^{II}—Me sites, which act as pseudo-open metal sites that interact selectively with a strong field ligand, namely carbon monoxide. In this putative mechanism, carbon monoxide induces a reorganization of the methyl substituent upon coordination to Co^{II} which leads to the formation of pseudo-octahedral sites capable of binding a second equivalent of carbon monoxide.

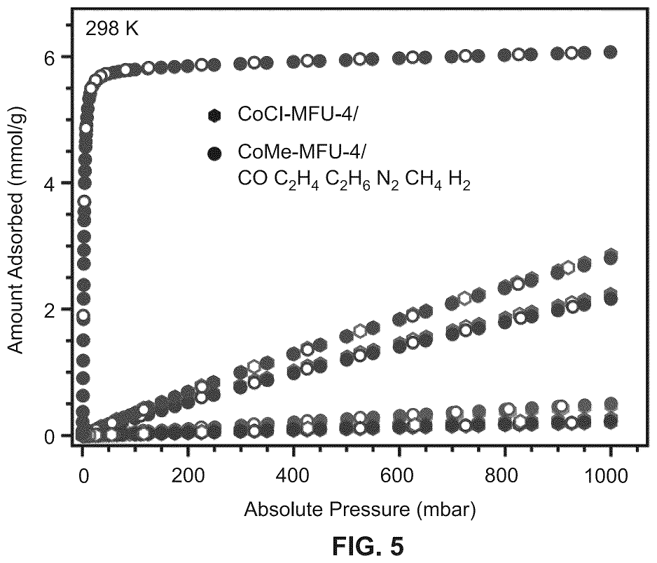

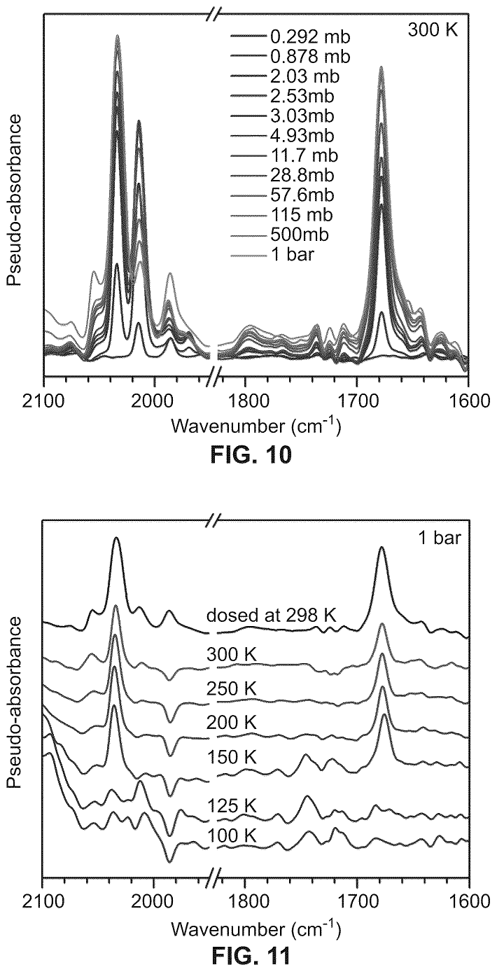

To test the affinity of the material for CO, a single component CO isotherm was taken at room temperature that is presented as FIG. 5. The CO adsorbed in the material featured steep uptake at low pressures that far exceeds the capacity of 3.5 mmol/g, which corresponds to one CO bound to Co^{II}. The CO lability and facile de-insertion from the alkyl group affords isothermal regeneration at room temperature which facilitates isothermal adsorption and desorption without degradation over extended cycling. As opposed to metal sites that start low-spin and therefore potentially bind CO irreversibly, a spin crossover mechanism starting from high-spin Co^{II} sites and transitioning to low-spin Co^{II} sites enables strong but reversible CO binding. This spin transition mechanism was corroborated by a comparison between the synthesized material and the in-situ CO dosed framework by using electron paramagnetic resonance, magnetic susceptibility, and powder X-ray diffraction measurements (See FIG. 10 and FIG. 11). In contrast to CO, single component isotherms of the framework with N₂, H₂, CH₄, and ethylene demonstrated weak nonspecific physisorptive interactions thus demonstrating that the metal sites selectively interact with CO as seen in FIG. 5.

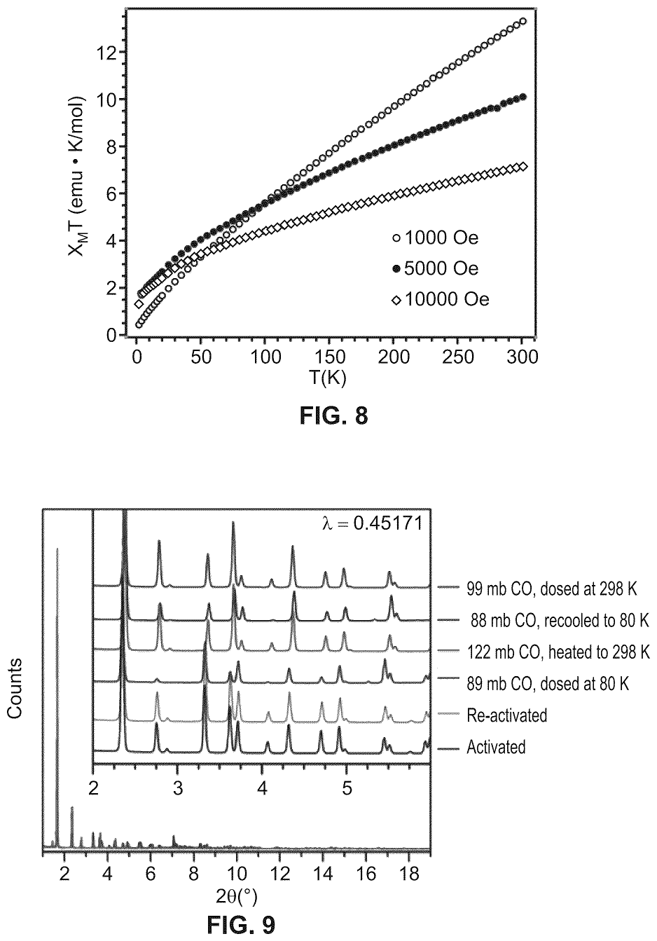

In-situ DRIFTS was used to understand the mechanism of CO binding to the Co^{II}—Me sites. Multi-gas adsorption was confirmed upon CO dosing the material with increasing pressure as two sets of peaks grew in concomitantly: one set indicative of CO terminally bound to Co (ν_{CO}>1960 cm⁻¹) and the other peak indicative of Co-acyl formation from CO migratory insertion into the Co—Me bond (ν_{CO}<1700 cm⁻¹) (FIG. 7). These values parallel stretches observed in the IR for analogous molecular tris(pyrazolyl)borate Co^{II} systems. Variable temperature DRIFTS under one bar of carbon monoxide elucidated that the first step involves the formation of a terminally bound CO as the peaks (ν_{CO}>1960 cm⁻¹) appear at 100 K as shown in FIG. 8. Upon heating the sample, a rapid migratory insertion transpires as the acyl peak (ν_{CO}<1700 cm⁻¹) begins to form at 150 K.

It will be appreciated that metal-organic frameworks with open metal sites are especially well-suited for selective solid gas interactions because of their porosity and the potential for a high-density of tunable metal sites. However, competition between sorbates for binding to the open metal sites can hamper the ability to achieve high selectivity for a single component. The family of frameworks enables the selective interaction of high-spin tetrahedral Co^{II}—Me sites, that act as masked open metal sites, that interact only with a CO. Because of the required reorganization and spin transition, the Co—Me sites selectively interact with multiple equivalents of the only strong field ligand in a putative mixture, namely carbon monoxide. Given that the metal sites lead to the strong interactions with gases under ambient conditions, the selective interaction of the metal sites with carbon monoxide over other components in the mixture will lead to high purities for the separated CO.

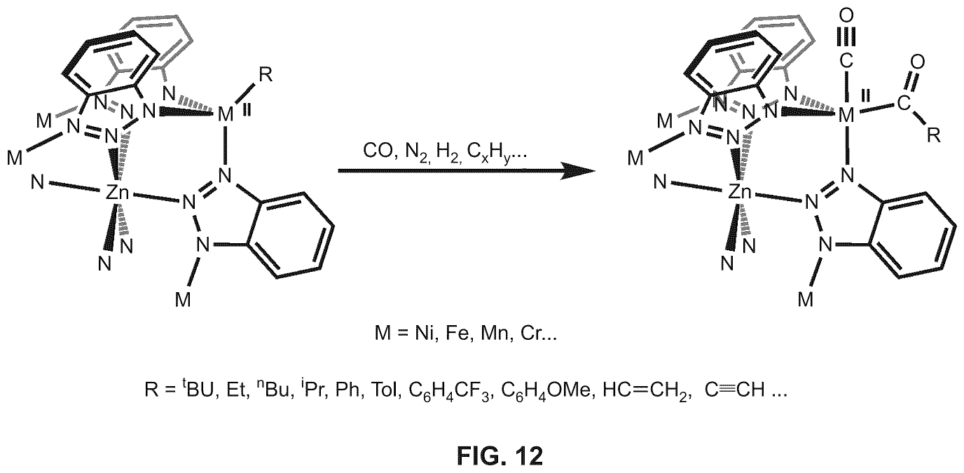

The other potential sorbates in the mixture are shown to only undergo weak nonspecific physisorptive interactions and are easily separated. The fact that the Co^{II} sites interact with multiple equivalents of CO at low pressures upon methyl reorganization and migratory insertion leads to high capacities of CO and further enhances separations. Additionally, the desorption of CO is sluggish because of the methyl reorganization and the spin transition mechanism. This further facilitates separation of CO from the other components, which desorb rapidly, due to high capacities for CO at low pressures, slow desorption of CO, and only weak physisorptive interactions with the other components in the mixture. These factors lead to an economically attractive purification process. Moreover, exploring the effects of various substituents (R=e.g., vinyl, aryl, alkynyl, etc.) and divalent metals (M=e.g., Co, Fe, Mn, etc.) is expected to have a profound impact on the selective binding of carbon monoxide in the system because the electronic structure, and thus the reactivity of the system and may be altered significantly as illustrated in FIG. 12.

Embodiments of the technology of this disclosure may be described herein with reference to flowchart illustrations of methods and systems according to embodiments of the technology. Embodiments of the technology of this disclosure may also be described with reference to procedures, algorithms, steps, operations, formulae, or other computational depictions, which may be included within the flowchart illustrations or otherwise described herein. It will be appreciated that any of the foregoing may also be implemented as computer program instructions. In this regard, each block or step of a flowchart, and combinations of blocks (and/or steps) in a flowchart, as well as any procedure, algorithm, step, operation, formula, or computational depiction can be implemented by various means, such as hardware, firmware, and/or software including one or more computer program instructions embodied in computer-readable program code. As will be appreciated, any such computer program instructions may be executed by one or more computer processors, including without limitation a general purpose computer or special purpose computer, or other programmable processing apparatus to produce a machine, such that the computer program instructions which execute on the computer processor(s) or other programmable processing apparatus create means for implementing the function(s) specified.

Accordingly, blocks of the flowcharts, and procedures, algorithms, steps, operations, formulae, or computational depictions described herein support combinations of means for performing the specified function(s), combinations of steps for performing the specified function(s), and computer program instructions, such as embodied in computer-readable program code logic means, for performing the specified function(s). It will also be understood that each block of the flowchart illustrations, as well as any procedures, algorithms, steps, operations, formulae, or computational depictions and combinations thereof described herein, can be implemented by special purpose hardware-based computer systems which perform the specified function(s) or step(s), or combinations of special purpose hardware and computer-readable program code.

Furthermore, these computer program instructions, such as embodied in computer-readable program code, may also be stored in one or more computer-readable memory or memory devices that can direct a computer processor or other programmable processing apparatus to function in a particular manner, such that the instructions stored in the computer-readable memory or memory devices produce an article of manufacture including instruction means which implement the function specified in the block(s) of the flowchart(s). The computer program instructions may also be executed by a computer processor or other programmable processing apparatus to cause a series of operational steps to be performed on the computer processor or other programmable processing apparatus to produce a computer-implemented process such that the instructions which execute on the computer processor or other programmable processing apparatus provide steps for implementing the functions specified in the block(s) of the flowchart(s), procedure(s) algorithm(s), step(s), operation(s), formula(e), or computational depiction(s).

It will further be appreciated that the terms “programming” or “program executable” as used herein refer to one or more instructions that can be executed by one or more computer processors to perform one or more functions as described herein. The instructions can be embodied in software, in firmware, or in a combination of software and firmware. The instructions can be stored locally to the device in non-transitory media or can be stored remotely such as on a server, or all or a portion of the instructions can be stored locally and remotely. Instructions stored remotely can be downloaded (pushed) to the device by user initiation, or automatically based on one or more factors.

It will further be appreciated that as used herein, the terms controller, microcontroller, processor, microprocessor, hardware processor, computer processor, central processing unit (CPU), and computer are used synonymously to denote a device capable of executing the instructions and communicating with input/output interfaces and/or peripheral devices, and that the terms controller, microcontroller, processor, microprocessor, hardware processor, computer processor, CPU, and computer are intended to encompass single or multiple devices, single core and multicore devices, and variations thereof.

From the description herein, it will be appreciated that the present disclosure encompasses multiple implementations of the technology which include, but are not limited to, the following:

A composition, comprising a metal-organic framework M-R-MFU-4/, where M is a divalent metal and R is a carbon substituent.

The composition of any preceding or following implementation, wherein the metal is a metal selected from the group consisting of Mn, Fe and Co.

The composition of any preceding or following implementation, wherein the R is a substituent selected from the group of alkanes, alkenes, and alkynes.

The composition of any preceding or following implementation, wherein the R is a substituent selected from the group of vinyl, aryl, and alkynyl substituents.

The composition of any preceding or following implementation, comprising a metal-organic framework CoMe-MFU-4/.

The composition of any preceding or following implementation, comprising a metal-organic framework CoCl-MFU-4/.

A method for removing CO from a mixed gas stream, the method comprising: (a) providing a stream of mixed gases containing CO for separation; (b) adsorbing CO from the stream of gases on a porous metal-organic framework (MOF) adsorbent, the framework comprising M-R-MFU-4/, where M is a divalent metal and R is a carbon substituent; (c) releasing the adsorbed non-CO gases from the framework; and (d) recovering remaining CO from the framework and regenerating the framework.

The method of any preceding or following implementation, wherein the metal of the framework is a metal selected from the group consisting of Mn, Fe and Co.

The method of any preceding or following implementation, wherein the R of the framework is a substituent selected from the group of alkanes, alkenes, and alkynes.

The method of any preceding or following implementation, wherein the R of the framework is a substituent selected from the group of vinyl, aryl, and alkynyl substituents.

The method of any preceding or following implementation, wherein the metal-organic framework comprises CoMe-MFU-4/.

The method of any preceding or following implementation, further comprising recovering the released non-CO gases from the framework and separating one or more non-CO gases from the recovered gases.

The method of any preceding or following implementation, wherein the mixed stream of gases comprise one or more gases selected from the group consisting of N₂, H₂, CH₄, and ethylene in addition to CO.

A method for gas separations, the method comprising: (a) providing a bed of metal organic frameworks of formula M-R-MFU-4/, where M is a divalent metal and R is a carbon substituent (b) exposing the bed of metal organic frameworks to a flow of gases to be separated; and (c) releasing adsorbed gases from the metal organic frameworks after a period of time.

The method of any preceding or following implementation, wherein the metal of the framework is a metal selected from the group consisting of Mn, Fe and Co.

The method of any preceding or following implementation, wherein the R of the framework is a substituent selected from the group of alkanes, alkenes, and alkynes.

The method of any preceding or following implementation, wherein the R of the framework is a substituent selected from the group of vinyl, aryl, and alkynyl substituents.

The method of any preceding or following implementation, wherein the metal-organic framework comprises CoMe-MFU-4/.

The method of any preceding or following implementation, further comprising controlling temperature and pressure of the stream of gases at a time of adsorption.

The method of any preceding or following implementation, further comprising recovering the released non-CO gases from the framework; and separating one or more non-CO gases from the recovered gases.

As used herein, the term “implementation” is intended to include, without limitation, embodiments, examples, or other forms of practicing the technology described herein.

As used herein, the singular terms “a,” “an,” and “the” may include plural referents unless the context clearly dictates otherwise. Reference to an object in the singular is not intended to mean “one and only one” unless explicitly so stated, but rather “one or more.”

Phrasing constructs, such as “A, B and/or C . . . ” within the present disclosure describe where either A, B, or C can be present, or any combination of items A, B and C. Phrasing constructs indicating, such as “at least one of” followed by listing a group of elements, indicates that at least one of these groups of elements is present, which includes any possible combination of the listed elements as applicable.

References in this disclosure referring to “an embodiment,” “at least one embodiment” or similar embodiment wording indicates that a particular feature, structure, or characteristic described in connection with a described embodiment is included in at least one embodiment of the present disclosure. Thus, these various embodiment phrases are not necessarily all referring to the same embodiment, or to a specific embodiment which differs from all the other embodiments being described. The embodiment phrasing should be construed to mean that the particular features, structures, or characteristics of a given embodiment may be combined in any suitable manner in one or more embodiments of the disclosed apparatus, system, or method.

As used herein, the term “set” refers to a collection of one or more objects. Thus, for example, a set of objects can include a single object or multiple objects.

Relational terms such as first and second, top and bottom, upper and lower, left and right, and the like, may be used solely to distinguish one entity or action from another entity or action without necessarily requiring or implying any actual such relationship or order between such entities or actions.

The terms “comprises,” “comprising,” “has”, “having,” “includes”, “including,” “contains”, “containing” or any other variation thereof, are intended to cover a non-exclusive inclusion, such that a process, method, article, apparatus, or system, that comprises, has, includes, or contains a list of elements does not include only those elements but may include other elements not expressly listed or inherent to such process, method, article, apparatus, or system. An element proceeded by “comprises . . . a”, “has . . . a”, “includes . . . a”, “contains . . . a” does not, without more constraints, preclude the existence of additional identical elements in the process, method, article, apparatus, or system, that comprises, has, includes, contains the element.

As used herein, the terms “approximately”, “approximate”, “substantially”, “substantial”, “essentially”, and “about”, or any other version thereof, are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1 %, less than or equal to ±0.5%, less than or equal to ±0.1 %, or less than or equal to ±0.05%. For example, “substantially” aligned can refer to a range of angular variation of less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

The term “coupled” as used herein is defined as connected, although not necessarily directly and not necessarily mechanically. A device or structure that is “configured” in a certain way is configured in at least that way but may also be configured in ways that are not listed.

Benefits, advantages, solutions to problems, and any element(s) that may cause any benefit, advantage, or solution to occur or become more pronounced are not to be construed as a critical, required, or essential feature or element of the technology described herein or any or all the claims.

In addition, in the foregoing disclosure various features may be grouped together in various embodiments for the purpose of streamlining the disclosure. This method of disclosure is not to be interpreted as reflecting an intention that the claimed embodiments require more features than are expressly recited in each claim. Inventive subject matter can lie in less than all features of a single disclosed embodiment.

The abstract of the disclosure is provided to allow the reader to quickly ascertain the nature of the technical disclosure. It is submitted with the understanding that it will not be used to interpret or limit the scope or meaning of the claims.

It will be appreciated that the practice of some jurisdictions may require deletion of one or more portions of the disclosure after the application is filed. Accordingly, the reader should consult the application as filed for the original content of the disclosure. Any deletion of content of the disclosure should not be construed as a disclaimer, forfeiture, or dedication to the public of any subject matter of the application as originally filed.

All text in a drawing figure is hereby incorporated into the disclosure and is to be treated as part of the written description of the drawing figure.

The following claims are hereby incorporated into the disclosure, with each claim standing on its own as a separately claimed subject matter.

Although the description herein contains many details, these should not be construed as limiting the scope of the disclosure, but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. A composition, comprising:
a metal-organic framework M-R-MFU-4/, where M is a divalent metal and R is a carbon substituent.

2. The composition of claim 1, wherein the divalent metal is a metal selected from the group consisting of Mn, Fe and Co.

3. The composition of claim 1, wherein the R is a substituent selected from the group of alkanes, alkenes, and alkynes.

4. The composition of claim 1, wherein the R is a substituent selected from the group of vinyl, aryl, and alkynyl substituents.

5. The composition of claim 1, comprising:
a metal-organic framework CoMe-MFU-4/.

6. The composition of claim 1, comprising:
a metal-organic framework CoCl-MFU-4/.

7. A method for removing CO from a mixed gas stream, the method comprising:
(a) providing a stream of mixed gases containing CO for separation;
(b) adsorbing CO from the stream of gases on a porous metal-organic framework (MOF) adsorbent, the framework comprising M-R-MFU-4/, where M is a divalent metal and R is a carbon substituent;
(c) releasing the adsorbed non-CO gases from the framework; and
(d) recovering remaining CO from the framework and regenerating the framework.

8. The method of claim 7, wherein the divalent metal of the framework is a metal selected from the group consisting of Mn, Fe and Co.

9. The method of claim 7, wherein the R of the framework is a substituent selected from the group of alkanes, alkenes, and alkynes.

10. The method of claim 7, wherein the R of the framework is a substituent selected from the group of vinyl, aryl, and alkynyl substituents.

11. The method of claim 7, wherein the metal-organic framework comprises CoMe-MFU-4/.

12. The method of claim 7, further comprising:
recovering the released non-CO gases from the framework; and
separating one or more non-CO gases from the recovered gases.

13. The method of claim 7, wherein the mixed stream of gases comprise one or more gases selected from the group consisting of N₂, H₂, CH₄, and ethylene in addition to CO.

14. A method for gas separations, the method comprising:
(a) providing a bed of metal organic frameworks of formula M-R-MFU-4/, where M is a divalent metal and R is a carbon substituent;
(b) exposing the bed of metal organic frameworks to a flow of gases to be separated; and
(c) releasing adsorbed gases from the metal organic frameworks after a period of time.

15. The method of claim 14, wherein the divalent metal of the framework is a metal selected from the group consisting of Mn, Fe and Co.

16. The method of claim 14, wherein the R of the framework is a substituent selected from the group of alkanes, alkenes, and alkynes.

17. The method of claim 14, wherein the R of the framework is a substituent selected from the group of vinyl, aryl, and alkynyl substituents.

18. The method of claim 14, wherein the metal-organic framework comprises CoMe-MFU-4/.

19. The method of claim 14, further comprising:
controlling temperature and pressure of the stream of gases at a time of adsorption.

20. The method of claim 14, further comprising:
recovering the released non-CO gases from the framework; and
separating one or more non-CO gases from the recovered gases.
